(19) United States
(12) Patent Application Publication
(10) Pub. No.: US 2006/0170223 A1
(43) Pub. Date: Aug. 3, 2006

(54) Computer latch

(76) Inventors: Steven S. Homer, Tomball, TX (US); Ronald E. Deluga, Spring, TX (US); Earl W. Moore, Cypress, TX (US); Kenneth D. Reddix, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/051,215

(22) Filed: Feb. 1, 2005

(51) Int. Cl. E05C 19/10

(52) U.S. Cl. 292/102; 361/683

(57) ABSTRACT

In certain embodiments, a system has a first structure, a second structure, and at least one plastic-over-metal latch configured to interlock the first structure to the second structure.

### BACKGROUND OF THE RELATED ART

Electronic devices, such as computers, often include latches to secure one component to another. For example, laptop computers generally have one or more latches to secure a panel display to a base housing. Latches also secure portable electronics, such as laptops, to docking stations. In consumer electronics, these latches and the structures they engage are typically plastic. Plastics are advantageous for several reasons, including relatively low manufacturing costs, relatively low frictional resistance between mechanical components, and relatively high moldability into intricate mechanical components and aesthetically pleasing designs. Disadvantages of plastics include relatively high susceptibility to wear and breakage. For this reason, consumers favor solid metal components, such as metal latches, because of the perceived ruggedness. Unfortunately, these solid metal latches scuff and wear the surfaces of the plastic structures they engage. For example, a metal latch disposed on a panel display of a laptop computer would scuff and wear against a plastic base housing to which the latch is securable. For these reasons, a latch made of solid plastic or metal is problematic for electronic devices, such as computers.

### BRIEF DESCRIPTION OF THE DRAWINGS

Advantages of one or more disclosed embodiments may become apparent upon reading the following detailed description and upon reference to the drawings in which:

FIGS. 1-4 are cross-sectional side views of a system having a latch interlocking first and second components or panels in accordance with embodiments of the present invention;

FIG. 5 is a cross-sectional front view of the latch illustrated in FIGS. 1-4;

FIG. 6 is a side view of a portable computer having a latch in accordance with embodiments of the present invention;

FIG. 7 is a front perspective view of the portable computer illustrated in FIG. 6;

FIG. 8 is a rear view of a portable computer exploded from a docking unit having a pair of latches in accordance with embodiments of the present invention; and

FIG. 9 a rear perspective view of an alternative embodiment having a panel display or tablet computer exploded from a keyboard having a pair of latches.

### DETAILED DESCRIPTION

As discussed in detail below, embodiments of the present invention comprise plastic-over-metal latches, i.e., latches having a plastic exterior disposed about a metal core. As compared to a solid plastic latch, the metal core increases the ruggedness of the latch. As compared to a solid metal latch, the plastic exterior decreases the frictional resistance against other plastic components. As a result, the plastic exterior reduces the amount of scuffing and wear that an otherwise solid metal latch would inflict on the other plastic components.

In certain embodiments, the plastic exterior comprises a material configured to enable the user to observe or visualize the metal core, such that the user perceives the ruggedness of the plastic-over-metal latch. In other words, the plastic exterior permits at least some light from passing through the plastic exterior to the metal core, such that the metal core can be observed with some degree of clarity. This visual perceptibility of the metal core through the plastic exterior can be attributed to a translucent material of the plastic exterior. The translucence of the plastic exterior may be defined as permitting light passage and visibility ranging between a minimum or blurred visibility to a maximum or clear visibility (e.g., transparent). In some systems and devices, this visualization of the metal core also enables the user to observe fatigue, stress cracks, or structural defects of the metal core, thereby enabling the user to replace the plastic-over-metal latch prior to complete failure.

As recognized by those of ordinary skill the art, a variety of manufacturing techniques may be utilized to create a latch having a metal core and plastic exterior. For example, embodiments of the plastic-over-metal latch are formed by molding the plastic exterior about the metal core. Specifically, the plastic exterior may be formed by injecting a plastic material into a molding tool surrounding the metal core, and subsequently removing the molding tool to leave behind the plastic material molded about the metal core. Other embodiments of the latch are formed by spray coating the plastic exterior onto the metal core or, alternatively, by dipping the metal core into a plastic material to form the plastic exterior. Regarding the mechanics of the plastic-over-metal latch, embodiments have different geometries and coupling features, such as hooks, snaps, lips, ramps, bosses, and so forth. Moreover, the plastic-over-metal latch is applicable to a variety of systems and devices, such as laptop computers, tablet computers, palmtop computers, docking stations, displays, keyboards, and other electronic and non-electronic devices. By further example, the plastic-over-metal latch is applicable to a variety of enclosures, consumer products, and industrial products.

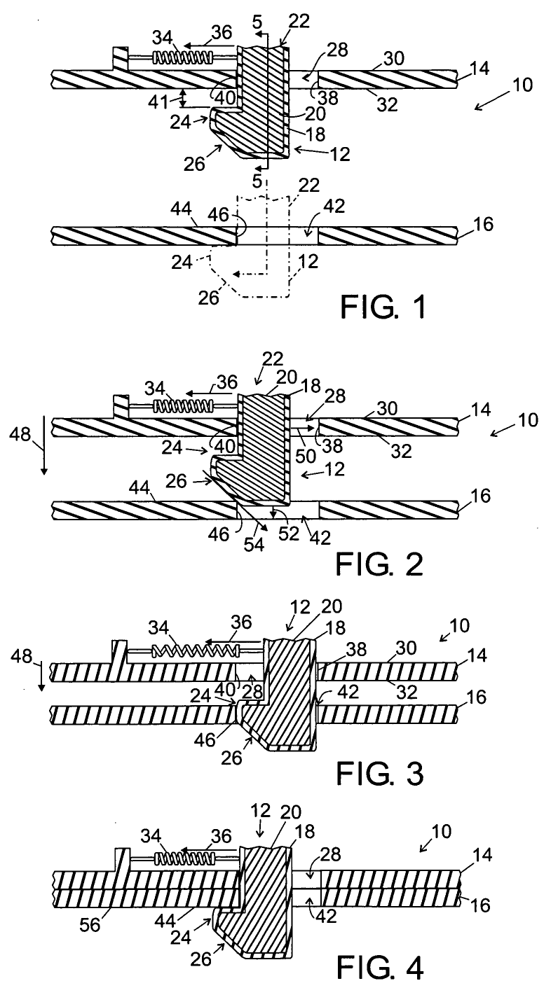

Turning now to the drawings, FIGS. 1-4 are cross-sectional side views of a system 10 having a plastic-over-metal latch 12 interlocking first and second components, housings, devices, surfaces or structures 14 and 16 in accordance with embodiments of the present invention. In certain embodiments, the system 10 includes a variety of electronics or computer components disposed in or coupled to one or both of the first and second surfaces or structures 14 and 16. For example, embodiments of the system 10 include a display, a docking unit (e.g., a port replicator, a docking station, or another type of docking unit), an input device (e.g., a mouse, a keyboard, or a digitizer pad), a portable computer (e.g., a laptop, a palmtop, or a tablet personal computer), a printer, or other electronic devices. By further example, embodiments of the first and second surfaces or structures 14 and 16 comprise component housings having electronics, such as circuit boards, processors, memory, disk drives, audio circuitry, video circuitry, network circuitry, and so forth. As appreciated by one of ordinary skill in the art, one or more of the plastic-over-metal latches 12 are mountable to a variety of different components, housings, devices, surfaces or structures, such as, but not limited to, those mentioned above.

With reference to FIG. 1, the plastic-over-metal latch 12 has a plastic exterior 18 disposed about a metal core 20, such that the plastic-over-metal latch 12 has a relatively low friction and a relatively rugged structure. In certain embodiments of the plastic-over-metal latch 12, the plastic exterior 18 is at least partially formed of a transparent or translucent material, which enables the user to view, visualize or perceive the ruggedness associated with the metal core 20. In some applications, this visibility of the metal core 20 through the plastic exterior 18 enables a user to observe fatigue, stress cracks, or structural defects of the metal core 20, thereby facilitating timely replacement of the plastic-over-metal latch 12 prior to complete failure. Embodiments of the plastic exterior 18 include a substantially clear or cloudy material with or without coloring, such as red, blue, green, or yellow. In other embodiments, the plastic exterior 18 has an opaque portion surrounding a window portion, which is configured to enable a user to observe the metal core 20. The plastic-over-metal latch 12 can be formed by a variety of manufacturing techniques, such as molding, spray coating, dip coating, and so forth. For example, one exemplary molding technique involves injecting a plastic material into a molding tool disposed about the metal core, and subsequently removing the molding tool. Another technique involves dipping the metal core into a plastic material, and subsequently solidifying the plastic material to form the plastic exterior. A further technique involves spraying coating a plastic material onto the metal core to form the plastic exterior.

As illustrated in FIG. 1, the structure of the plastic-over-metal latch 12 includes a support portion 22, a recessed catch or lip 24, and a ramp or angled portion 26. In other words, the plastic-over-metal latch 12 has a wedge-shaped head represented by numeral 26, which recesses to the catch or lip 24 at a point disposed inward from the peak of the wedge-shaped head 26. However, alternative embodiments of the plastic-over-metal latch 12 include different structural features as recognized by those of ordinary skill in the art. As illustrated, the plastic-over-metal latch 12 is movably mounted to the first surface or structure 14, such that the support portion 22 extends through a first receptacle or slot 28 from a first side 30 to a second side 32. At the first side 30, the support portion 22 is coupled to a spring 34 that biases the plastic-over-metal latch 12 in a leftward direction 36 away from a right end 38 toward a left end 40 of the first receptacle or slot 28. At the second side 32, the support structure 22 projects outwardly to the lip 24 and the angled portion 26, such that the lip 24 is positioned at an offset 41 from the second side 32. As discussed in further detail below with reference to FIGS. 2-4, the ramp or angled portion 26 facilitates a relatively smooth engagement of the plastic-over-metal latch 12 with a mating portion, e.g., a second receptacle or slot 42, of the second surface or structure 16, such that the lip 24 can pass through the second receptacle or slot 42. The offset 41 then enables the lip 24 to interlock with a peripheral portion 44 of the second surface or structure 16 at a left side 46 of the second receptacle or slot 42. In certain embodiments, the first and/or second surfaces or structures 14 and 16 are plastic in the area of the plastic-over-metal latch 12, thereby creating a plastic-on-plastic sliding engagement with the surface of the plastic-over-metal latch 12 and slot 42. Thus, the plastic exterior 18 of the plastic-over-metal latch 12 reduces friction, scuffing, and wear against the plastic material of the mating portion, e.g., a second receptacle or slot 42, of the second surface or structure 16.

As illustrated in FIG. 2, the initial engagement between the plastic-over-metal latch 12 and the second receptacle or slot 42 occurs at the ramp or angled portion 26. As the first and second surfaces or structures 14 and 16 move toward one another as indicated by arrow 48, the angled portion 26 slides the plastic-over-metal latch 12 rightwardly 50 and downwardly 52 into the second receptacle or slot 42 as represented by arrow 54. In other words, the ramp or angled portion 26 wedgingly pushes the support portion 22 of the plastic-over-metal latch 12 along the first receptacle or slot 28 in the rightward direction 50 in opposition to the spring 34. As a result of this rightward movement 50 of the plastic-over-metal latch 12, the angled portion 26 moves the plastic-over-metal latch 12 progressively downward 52 into the second receptacle or slot 42.

After sufficient downward movement 52, the catch or lip 24 of the plastic-over-metal latch 12 slides into the second receptacle or slot 42 as illustrated in FIG. 3. Upon reaching a bottom side 56 of the second surface or structure 16, the catch or lip 24 is pulled leftwardly by the spring 34 as illustrated in FIG. 4. In other words, the spring 34 biases the lip 24 toward the left side 46 of the second receptacle or slot 42, such that the catch or lip 24 is vertically secured below the peripheral portion 44 of the second surface or structure 16. At this position, the plastic-over-metal latch 12 and spring 34 cooperatively retain the first and second surfaces or structures 14 and 16 in close proximity with one another.

The first and second surfaces or structures 14 and 16 can be freed or unlocked from one another by moving the plastic-over-metal latch 12 in a rightward direction in opposition to the spring 34. With sufficient rightward movement of the plastic-over-metal latch 12, the catch or lip 24 can pass through the second receptacle or slot 42. As a result, the first and second surfaces or structures 14 and 16 can then be separated from one another by moving the plastic-over-metal latch 12 in an upward direction out of the second receptacle or slot 42.

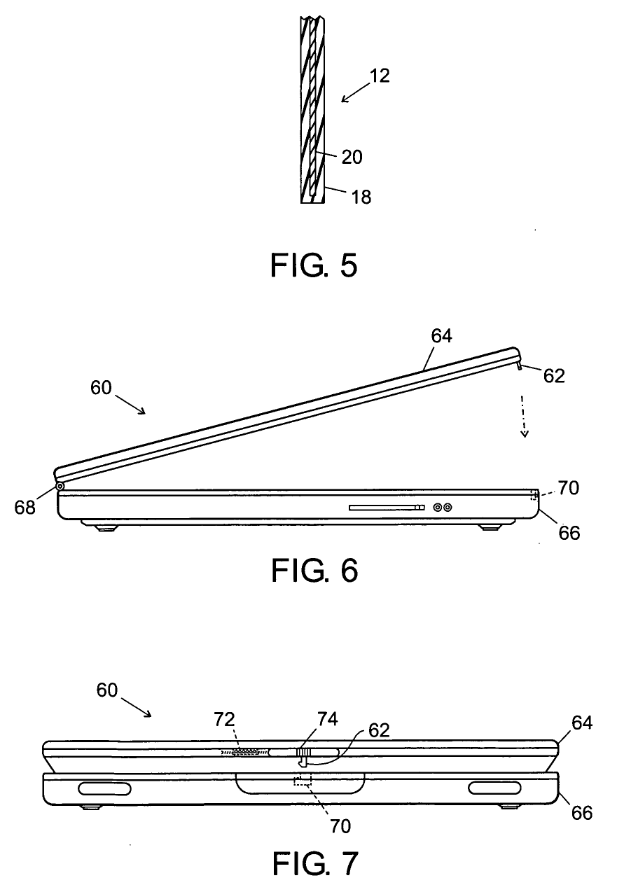

FIG. 5 is a cross-sectional front view of the plastic-over-metal latch 12 having the plastic exterior 18 and metal core 20 illustrated in FIGS. 1-4. Again, as discussed above, the plastic exterior 18 of the plastic-over-metal latch 12 provides a relatively smooth interface, e.g., low friction, such that the plastic-over-metal latch 12 can engage and disengage the second receptacle or slot 42 with relatively minor or no wear or scuffing of the second surface or structure 16. In addition, the metal core 20 increases the rigidity and ruggedness of the plastic-over-metal latch 12. In certain embodiments, the plastic exterior 18 is translucent or transparent, such that the user can visually perceive this increased rigidity or ruggedness associated with the metal core 20. A user may also be able to observe structural defects, fatigue, etc. to facilitate timely replacement of the plastic-over-metal latch 20. The metal core 20 also enables the plastic-over-metal latch 12 to have a relatively smaller thickness than an all-plastic latch, thereby reducing space consumption of the plastic-over-metal latch 12. This reduced size is particularly useful in compact electronics, such as panel displays and portable computers.

FIG. 6 is a side view of a portable computer 60 having a plastic-over-metal latch 62 in accordance with embodiments of the present invention. In certain embodiments, the portable computer 60 comprises a laptop computer, a notebook computer, a tablet computer, a desktop computer, or other portable or stationary electronics or devices. Again, the illustrated plastic-over-metal latch 62 has a metal core surrounded by a plastic exterior, such as a transparent or translucent outer coating. In the illustrated embodiment, the plastic-over-metal latch 62 is mounted to a display or display panel 64, such as a liquid crystal display module, which is coupled to a component housing or base 66 via a hinge 68. The component housing or base 66 comprises a mating receptacle or slot 70, which interlocks with the plastic-over-metal latch 62 upon closure of the display panel 64 against the component housing or base 66. The component housing or base 66 includes a variety of components, such as a processor, memory, a disk drive, video circuitry, audio circuitry, and so forth. In certain embodiments, the component housing or base 66 may include additional mating receptacles or slots 70, which interlock with additional plastic-over-metal latches 62. For example, the portable computer 60 can comprise a pair of plastic-over-metal latches 62 disposed on opposite sides (e.g., left and right), rather than in the front center of the computer 60 as shown in FIG. 6. By further example, the portable computer 60 can comprise one or more of the plastic-over-metal latches 62 disposed on left and/or right front portions, rather than in the front center of the computer 60 as shown in FIG. 6. Other numbers and configurations of these plastic-over-metal latches 60 also may be employed on electronics, devices, computers, surfaces, and structures in accordance with embodiments of the present technique.

FIG. 7 is a front perspective view of the portable computer 60 illustrated in FIG. 6. As illustrated, the display panel 64 is partially closed relative to the component housing or base 66, such that the plastic-over-metal latch 62 is positioned directly above the mating receptacle or slot 70. In this exemplary embodiment, the plastic-over-metal latch 62 is coupled to a spring 72, which biases the plastic-over-metal latch 62 in a leftward direction. As the display panel 64 closes onto the component housing or base 66, the plastic-over-metal latch 62 slidingly engages and passes through the mating receptacle or slot 70. The spring 72 then pulls the plastic-over-metal latch 62 leftwardly into a locked position within the mating receptacle or slot 70. At this position, the plastic-over-metal latch 62 and spring 72 cooperatively retain the display panel 64 and the component housing or base 66 in close proximity with one another. The display panel 64 can be opened by engaging a release mechanism 74, which moves the plastic-over-metal latch 62 out of the locked position relative to the mating receptacle or slot 70. Again, as discussed above, embodiments of the plastic-over-metal latch 62 include a variety of coupling mechanisms, such as hooks, tabs, bosses, catches, lips, and so forth. Moreover, in alternative embodiments of the portable computer 60, the plastic-over-metal latch 62 is mounted on the component housing or base 66 and the mating receptacle or slot 70 is positioned on the display panel 64.

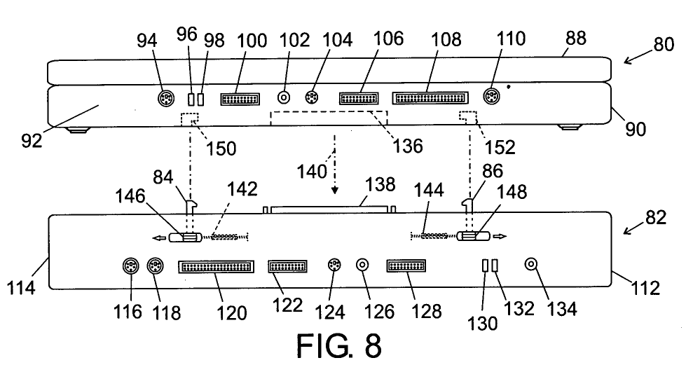

In alternative embodiments, electronic or other devices can be coupled together via one or more plastic-over-metal latches as described above. For example, FIG. 8 illustrates a rear view of such an embodiment having a portable computer 80 exploded from a docking station or unit 82 having a pair of plastic-over-metal latches 84 and 86 in accordance with embodiments of the present invention. In certain embodiments, the portable computer 80 and the docking unit 82 are coupled together by more or less than the illustrated pair of plastic-over-metal latches 84 and 86. Moreover, the one or more plastic-over-metal latches (e.g., 84 and 86) can be disposed in the front, rear, sides, or other positions capable of connecting the portable computer 80 to the docking unit 82. Again, the illustrated plastic-over-metal latches 84 and 86 each have a metal core surrounded by a plastic exterior, such as a transparent or translucent outer coating. In certain embodiments, the portable computer 80 is a laptop computer, a tablet computer, a palmtop computer, or another portable electronic device. As illustrated, the portable computer 80 comprises a display 88, a component housing 90, and a communication panel 92 having connectors 94-110. The illustrated docking unit 82 comprises a base structure 112 and a communication panel 114 having connectors 116-134. Embodiments of these communication connectors 94-110 and 116-134 have serial ports, parallel ports, universal serial bus (USB) ports, audio ports, video ports, keyboard ports, and mouse ports. The portable computer 80 also comprises a docking communication connector 136, which connects with a mating communication connector 138 on the docking unit 82 as the portable computer 80 moves toward the docking unit 82 as indicated by arrow 140. As the connectors 136 and 138 mate with one another, the plastic-over-metal latches 84 and 86 interlock the portable computer 80 and the docking unit 82 in close proximity with one another.

In the illustrated embodiment of FIG. 8, the plastic-over-metal latches 84 and 86 are coupled to springs 142 and 144 and release mechanisms 146 and 148, respectively. As the portable computer 80 progressively connects with the docking unit 82, the plastic-over-metal latches 84 and 86 slidingly engage and pass through mating receptacles or slots 150 and 152, respectively, which are disposed in the portable computer 80. The springs 142 and 144 then pull the plastic-over-metal latches 84 and 86 into a locked position within the mating receptacles or slots 150 and 152, respectively. At this position, the plastic-over-metal latches 84 and 86 and the springs 142 and 144 cooperatively retain the portable computer 80 and the docking unit 82 in close proximity with one another. The portable computer 80 can be undocked from the docking unit 82 by engaging the release mechanisms 146 and 148, which move the plastic-over-metal latches 84 and 86 out of the locked positions relative to the mating receptacles or slots 150 and 152, respectively. Again, as discussed above, embodiments of the plastic-over-metal latches 84 and 86 include a variety of coupling mechanisms, such as hooks, tabs, bosses, lips, and so forth. Moreover, in alternative embodiments, the plastic-over-metal latches 84 and 86 are mounted on the portable computer 80 and the mating receptacles or slots 150 and 152 are positioned on the docking unit 82.

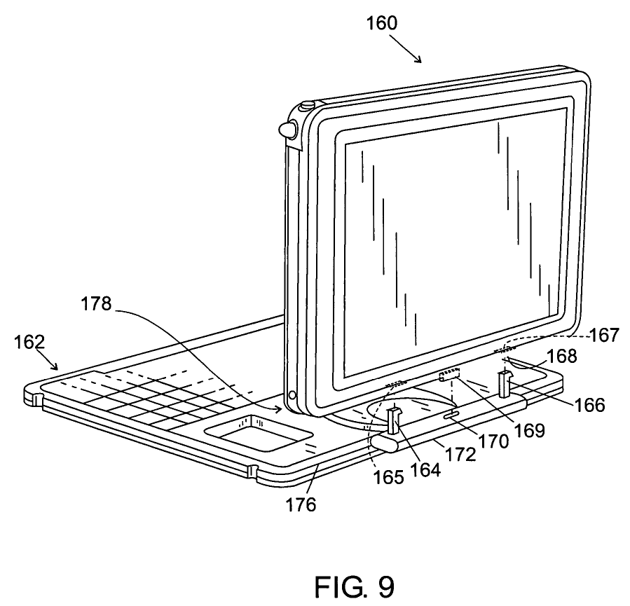

Other applications of the foregoing plastic-over-metal latches include tablet personal computers, keyboards, displays, and so forth. For example, FIG. 9 is a rear perspective view of a panel display or tablet personal computer 160 exploded from a keyboard 162 having a pair of plastic-over-metal latches 164 and 166 in accordance with embodiments of the present invention. For example, embodiments of the panel display or tablet personal computer 160 comprise a liquid crystal display, a touch screen, or other display technologies, while some embodiments can further comprise computer components such as a processor, memory, a disk drive, audio circuitry, etc. Again, the illustrated plastic-over-metal latches 164 and 166 each have a metal core surrounded by a plastic exterior, such as a transparent or translucent outer coating. These plastic-over-metal latches 164 and 166 connect with mating receptacles or slots 165 and 167 in a bottom side 168 of the panel display or tablet computer 160. Again, the plastic exterior of these plastic-over-metal latches 164 and 166 facilitates a relatively low friction engagement of these plastic-over-metal latches 164 and 166 with the mating receptacles or slots, thereby reducing the amount of scuffing and wear associated with their engagement and disengagement with one another. In certain embodiments, the panel display or tablet computer 160 is coupled to the keyboard 162 by one or more of the plastic-over-metal latches 164 and 166.

As further illustrated in FIG. 9, the panel display or tablet computer 160 comprises a docking communication connector 169, which connects with a mating communication connector 170 on the keyboard 162 as the panel display or tablet computer 160 moves toward the keyboard 162. As these connectors mate with one another, the plastic-over-metal latches 164 and 166 interlock the panel display or tablet computer 160 and the keyboard 162 with one another. To separate the panel display or tablet computer 160 from the keyboard 162, a release mechanism is engaged to move the plastic-over-metal latches 164 and 166 out of the locked position relative to the mating receptacles or slots 165 and 167.

In addition to these features, the panel display or tablet computer 160 docks with the keyboard 162 on a hinged structure 172 coupled to a rotatable disk structure 174. The hinged structure 172 enables the panel display or tablet computer 160 to rotate about an axis parallel to a rear side 176 of the keyboard 162, such that the panel display or tablet computer 160 can close onto the keyboard 162 in a clamshell configuration. The rotatable disk structure 174 enables the panel display or tablet computer 160 to rotate about an axis perpendicular to the surface of the keyboard 162, such that the panel display or tablet computer 160 can rotate toward an interior region 178 of the keyboard 162.

What is claimed is:

1. A system, comprising:
a first structure;
a second structure; and
at least one plastic-over-metal latch configured to interlock the first structure to the second structure.

2. The system of claim 1, wherein the at least one plastic-over-metal latch comprises a plastic exterior molded over a metal core.

3. The system of claim 1, wherein the at least one plastic-over-metal latch comprises a metal core visible through a plastic exterior.

4. A device, comprising:
a structure; and
at least one plastic-over-metal latch coupled to the structure, wherein the at least one plastic-over-metal latch is configured to couple the structure to an external device.

5. The device of claim 4, wherein the at least one plastic-over-metal latch comprises a molded plastic exterior disposed about a metal core.

6. The device of claim 4, wherein the at least one plastic-over-metal latch comprises a metal core surrounded by a translucent plastic.

7. A computer system, comprising:
a first electronic device; and
a second electronic device mateable with the first electronic device via at least one plastic-over-metal latch.

8. The computer system of claim 7, wherein the at least one plastic-over-metal latch comprises a plastic exterior comprising a translucent material.

9. The computer system of claim 7, wherein the at least one plastic-over-metal latch comprises a plastic exterior that is color highlighted.

10. The computer system of claim 7, wherein the at least one plastic-over-metal latch comprises a plastic exterior that is configured to facilitate viewing of structural characteristics of the metal core.

11. The computer system of claim 7, wherein the at least one plastic-over-metal latch comprises a plastic exterior molded onto a metal core.

12. The computer system of claim 7, wherein the at least one plastic-over-metal latch comprises a plastic exterior coated onto a metal core.

13. The computer system of claim 7, wherein the first electronic device comprises a display.

14. The computer system of claim 7, wherein the first electronic device comprises a portable computer and the second electronic device comprises a docking unit.

15. The computer system of claim 7, wherein the first electronic device comprises a display and the second electronic device comprises a keyboard.

16. A method of manufacturing a computer system, comprising:
providing a first computer device comprising a plastic-over-metal latch having a plastic exterior disposed about a metal core.

17. The method of claim 16, wherein providing the first computer device comprising the plastic-over-metal latch comprises injecting mold material into a molding tool about the metal core, and subsequently removing the molding tool.

18. The method of claim 16, wherein providing the first computer device comprising the plastic-over-metal latch comprises dipping the metal core into a plastic material, and subsequently solidifying the plastic material to form the plastic exterior.

19. The method of claim 16, wherein providing the first computer device comprising the plastic-over-metal latch comprises spraying coating a plastic material onto the metal core to form the plastic exterior.

20. The method of claim 16, wherein providing the first computer device comprising the plastic-over-metal latch comprises forming the plastic exterior at least partially with a translucent material.

21. The method of claim 16, wherein providing the first computer device comprises assembling a laptop computer having the plastic-over-metal latch configured to secure a panel display to a component housing.

22. The method of claim 16, wherein providing the first computer device comprises assembling a docking unit having the plastic-over-metal latch configured to secure the docking unit to a portable computer.

23. An electronic device, comprising:
a first component having a plastic portion;
a second component; and
a plastic-over-metal latch coupling the first component to the second component, wherein the plastic-over-metal latch comprises a metal core and a plastic exterior configured to slide along the plastic portion between locked and released positions of the plastic-over-metal latch.

24. The electronic device of claim 23, wherein the metal core is at least partially viewable through the plastic exterior.

25. A computer system, comprising:
a display;
a component housing hingedly coupled to the display; and
a latch configured to interlock the display to the component housing, wherein the latch comprises a metal core and a plastic exterior.

26. The computer system of claim 25, wherein the plastic exterior is configured to reduce friction against a mating portion having a plastic surface.

27. The computer system of claim 25, wherein the plastic exterior comprises a translucent material.
